(19) United States
(12) Patent Application Publication
(10) Pub. No.: US 2007/0203870 A1
(43) Pub. Date: Aug. 30, 2007

(54) GRAPH GENERATING METHOD, GRAPH GENERATING PROGRAM AND DATA MINING SYSTEM

(75) Inventor: Shigeru Saito, Chiyoda-ku (JP)

Correspondence Address: PEARNE & GORDON LLP, 1801 EAST 9TH STREET, SUITE 1200, CLEVELAND, OH, 44114-3108, US

(73) Assignee: INFOCOM CORPORATION, Tokyo (JP)

(21) Appl. No.: 11/459,153

(22) Filed: Jul. 21, 2006

(30) Foreign Application Priority Data
Feb. 3, 2006 (JP) 2006-027247

(51) Int. Cl. G06N 7/02

(52) U.S. Cl. 706/52

(57) ABSTRACT

The invention has the object of obtaining, at a high rate of success, graphs indicating the relationships between variables indicating the states of observed items which are the subjects of data mining, and improving the reliability of the outputted graphs. A method for generating a graph showing the relationships between variables comprises a step S2 of establishing a number of graphs to be generated, a step S5 of randomly establishing an order of variables X forming the set of all variables V, a step S6 of performing a process of reconstructing a graph showing the relationships between variables, and a step S10 of outputting a comprehensive graph including all edges existing in any of the graphs generated with each graph generation. In the graph reconstruction process, an inverse matrix of the correlation coefficient matrix is calculated, and the operation of determining the conditional independence relating to two variables which are the subject of the conditional independence determination is skipped if any of the diagonal elements relating to the two variables is greater than a predetermined threshold value.

### BACKGROUND OF THE INVENTION

(1) Field of the Invention

The present invention relates to a graph generating method, a graph generating program and a data mining system, and relates in particular to a graph generating method and graph generating program that use a process of reconstructing independent directed acyclic graphs to generate, from a set of observed data, a graph representing the relationships between variables indicating the states of observed items, and a data mining system displaying said graph to a user.

“Independent directed acyclic graph” is graph terminology. Acyclic refers to a graph without a cyclic closed path. Directed graphs are graphs in which all edges (paths) connecting nodes (vertices) are arrows having an arrowhead on one or both sides. Additionally, when a directed acyclic graph is such that the simultaneous probability density function of a set of variables consisting of variables each represented as a node can be defined in the form of a sequential factorization in accordance with the graph, that graph is referred to as an independent directed acyclic graph. Additionally, graphs in which all edges are undirected are referred to as undirected graphs, and graphs in which undirected edges coexist with arrows are referred to as partially undirected graphs. In the subsequent description, edges that are undirected shall be referred to as “undirected edges”, directed edges shall be referred to as “arrows”, and undirected edges and arrows shall be referred to collectively as “edges”. Furthermore, a graphs generated so as to contain all edges existing in a plurality of graphs obtained by each computation shall be referred to as a “comprehensive graph”.

(2) Description of the Related Art

Recent years have seen a rise in interest in data mining processes which use numerical techniques to discover, from large amounts of stored data, the relationships between observed phenomena or objects, or the relationships between multiple items given as attributes to observed phenomena or objects (hereinafter referred to as “relationships between observed items”). One data mining technique is to discover the relationships between observed items by reconstructing independent directed acyclic graphs. FIG. 1 is a drawing showing an example of an independent directed acyclic graph. In FIG. 1, Xᵢ(i=1-5) are nodes representing observed variables quantitatively indicating a state relating to an observed item. In this technique, the presence of edges indicating the relationships between the nodes as well as the types of edges and the directions of arrows are specified by applying numerical techniques to the observed variables. When there is an arrow going from node Xᵢ to node Xⱼ, the observed item relating to the observed variable Xᵢ is the cause of the observed item relating to the observed variable Xⱼ.

The set of all variables given as the total set of variables each representing observed items handled by data mining achieved by reconstructing an independent directed acyclic graph shall be represented by V={X₁, X₂, . . . , Xₚ}. The variables X forming the set of all observable variables may be continuous variables or discrete variables. For example, continuous variables are used to analyze the conditions of a paint job on an automobile body. The following variables are given: X₁, dilution rate; X₂, viscosity; X₃, gun speed; X₄, spray distance; X₅, atomization air pressure; X₆, pattern width; X₇, ejected amount; X₈, paint temperature; X₉, room temperature; X₁₀, humidity and X₁₁, adhesion.

The values of the above eleven variables are measured for the respective painting steps over a predetermined number of times N (e.g., N=50). That is, measurements consisting of eleven sets of data to the effect that when the paint was sprayed under conditions of paint dilution rate A, viscosity B, gun speed C, spray distance D, . . . , as a result of which the adhesion was E are performed fifty times. Then, a PC algorithm described below is applied to represent the relationship between the variables using an independent directed acyclic graph. As a result, it is possible to understand the relationship between the adhesion and the other observed items.

Once an independent directed acyclic graph is obtained, it becomes possible to determine the strengths of the relationships between the observed variables. FIG. 2 is a drawing in which partial regression coefficients P indicating the relational strengths are appended to the independent directed acyclic graph shown in FIG. 1. The following multiple regression equations can be established from this graph:

X₃=β₃₁X₁+β₃₂X₂+e₃

X₄=β₄₁X₁+e₄

X₅=β₅₃X₃+β₅₄X₄+e₅

By analyzing the above multiple regression equations using the least squares method, it is possible to estimate the partial regression coefficient β and the error e. That is, the data for all of the measurements are plugged in for each of the variables to determine the partial regression coefficient β and error e that minimizes the sum of the errors squared.

Additionally, the variables X forming the set of all variables V may be discrete. For example, when analyzing product quality, the following variables having discrete values may be used:

X₁, a variable indicating grades (7 grades) of {soft to hard}

X₂, a variable indicating grades (7 grades) of {flat to bulky}

X₃, a variable indicating grades (7 grades) of {glossy to not glossy}

X₄, a variable indicating grades (7 grades) of {coarse to fine}

Let us assume that a person evaluates a certain product as X₁=1, X₂=3, X₃=2 and X₄=7. This kind of evaluation is performed with respect to a predetermined number of people N (e.g., N=50). By applying a PC algorithm and performing a predetermined computation on the resulting data group with {X₁, X₂, X₃, X₄} as the set of all variables V, it is possible to obtain an independent directed acyclic graph representing the relationships between observed items just as in the case of the continuous variables.

Next, the PC algorithm shall be explained. The PC algorithm is performed by following the below-given steps:

Step 1: A completely undirected graph constructed by connecting, with undirected edges, all pairs of nodes among the nodes corresponding to the variables contained in the set of all variables V is taken as the initial state of the independent directed acyclic graph C.

Step 2: In order to perform the graph reconstruction in steps, a variable n is established to indicate each step. Additionally, n is given an initial value of 0.

Step 3: As an ordered pair of adjacent (connected by an edge) nodes (Xᵢ, Xⱼ) in graph C, a pair of nodes is selected in which the number of elements in Ad(C, Xᵢ)¥{Xⱼ} is n or more. Additionally, a partial set S of Ad(C, Xᵢ)¥{Xⱼ} with n elements is selected. Additionally, if the variable Xᵢ and variable Xⱼ are conditionally independent when given a partial set S, the edge Eᵢⱼ connecting the node Xᵢ and node Xⱼ is deleted, and the elements of S are registered as the elements of the Sepset(Xᵢ, Xⱼ). This is performed with respect to all ordered pairs of nodes (Xᵢ, Xⱼ) for which the number of elements in Ad(C, Xᵢ)¥{Xⱼ} is n or more.

Here, Ad(C, Xᵢ) represents the set of nodes adjacent to the node Xᵢ in a given graph C. Additionally, Ad(C, Xᵢ)¥{Xⱼ} represents the set of nodes obtained by eliminating the node Xⱼ from the set of nodes adjacent to the node Xᵢ in a given graph C.

In the following explanation, the independence of variable Xᵢ and variable Xⱼ shall be represented as “X_{i—}Xⱼ”. Additionally, the state in which the variable Xᵢ and the variable Xⱼ are conditionally independent when given a partial set S which is the null set or a set consisting of one or more variables other than the variable Xᵢ and the variable Xⱼ shall be represented as “X_{i—}Xⱼ|S”.

Next, a method of determining whether a variable Xᵢ and a variable Xⱼ are conditionally independent when given a partial set S shall be described. Here, it shall be assumed that the variable vector (X₁, X₂, . . . , Xₚ) follows a p-dimensional multivariate normal distribution. A variance-covariance matrix shall be denoted Σ=(σᵢⱼ), and the inverse matrix will be denoted Σ⁻¹=(σ^{ij}). In this case, “σ^{ij}=0” is equivalent to saying “the variable Xᵢ and the variable Xⱼ are conditionally independent when given a partial set consisting of the (p−2) variables other than the variable Xᵢ and the variable Xⱼ”. Additionally, when σ^{ij}=0, the partial correlation coefficient Pᵢⱼ=0. Therefore, if Pᵢⱼ can be assumed to be 0, it is possible to determine that the variable Xᵢ and the variable Xⱼ are conditionally independent.

For a variable series consisting of the variable Xᵢ, variable Xⱼ and partial set S, taking the correlation matrix π=(ρᵢⱼ) and its inverse matrix as π⁻¹=(ρ^{ij}), the partial correlation coefficient Pᵢⱼ of the variable Xᵢ and variable Xⱼ will be given as follows:

Pᵢⱼ=−ρ^{ij}/{(ρⁱⁱ)^{1/2}(ρ^{jj})^{1/2}}

Additionally, statistical hypothesis testing is used to determine whether it is possible to assume Pᵢⱼ=0. Expressing the conditions given the partial set S as pa, for a t-test of the partial correlation coefficient P_{ij|pa}(null hypothesis H₀:P_{ij|pa}=0), Pij|pa must have normality. Since there is no guarantee that the sample partial correlation coefficient will satisfy the hypothesis of normality in actual practice, P_{ij|pa} is Z-converted by Eq. 1:

$${Z}_{ij} = \frac{1}{2} ln \frac{1 + {P}_{ij \vert pa}}{1 - {P}_{ij \vert pa}} \qquad Eq . 1$$

Additionally, the Z-statistic is given by Eq. 2:

$$Z = \frac{{Z}_{ij}}{\sqrt{\frac{1}{m} - 3 - pa}} \qquad Eq . 2$$

In Eq. 2, “pa” represents the number of conditional degrees, in other words the number of variables contained in the partial set S, and m represents the number of observed data. Asymptotically, the Z-statistic represents a χ² distribution of the degrees of freedom m-3-pa. Taking the significance level as α, when Z>Z_{2/α}, the null hypothesis H₀:P_{ij|pa}=0 is rejected. When the null hypothesis cannot be rejected, it is assumed that P_{ij|pa}=0 and determined that the variable Xᵢ and variable Xⱼ are independent when given the partial set S. When the partial set S is the null set, the correlation coefficient Rᵢⱼ is used instead of the partial correlation coefficient Pᵢⱼ and the above method is applied with pa=0 to determine conditional independence.

Step 4: If the number of elements in Ad(C, Xᵢ)¥{Xⱼ} is n or less for an arbitrary pair of ordered nodes (Xᵢ, Xⱼ), the procedure advances to step 5. If not, step 3 is repeated with n=n+1.

Step 5: If graph C contains the structure Xᵢ-Xⱼ-Xₖ (Xᵢ and Xₖ are not adjacent) and Xⱼ is not among the elements in Sepset(Xᵢ, Xₖ), arrows are added such that Xᵢ→Xᵢ←Xₖ. While edge connections are referred to as paths, if the paths formed by Xᵢ, Xⱼ and Xₖ satisfy the above relationship when connected, this path is known as a V-structure.

When Xⱼ is present among the elements of Sepset(Xᵢ, Xₖ), Xᵢ and Xₖ become conditionally independent when given Xⱼ, so that X_{i—}Xₖ|Xᵢ. In an independent directed acyclic graph, the existence of a V-structure such as Xᵢ→Xⱼ←Xₖ proposes the property in which Xᵢ and Xₖ does not become conditionally independent when given an arbitrary set of variables containing Xⱼ. Therefore, if Xⱼ is not present among the elements of Sepset(Xᵢ, Xₖ) as described above, it is possible to add the arrows Xᵢ→Xᵢ←Xₖ.

In the following steps 6 and 7, orientation rules are applied to the graph C obtained by performing the procedure up to step 5, to convert the edges to arrows. FIG. 3 is a diagram showing orientation rules. FIG. 3(a) shows Rule 1 of the orientation rules. According to Rule 1, the directions of the arrows on the edges are determined based on the assumption that all V-structures have been detected by the procedure up to step 5. Additionally, FIG. 3(b) shows Rule 2 of the orientation rules. According to Rule 2, the directions of the arrows are determined based on the assumption that there are no cyclic paths.

Step 6: If the structure Xᵢ→Xⱼ-Xₖ exists and Xᵢ and Xₖ are not adjacent in a graph obtained by adding a number of arrows to graph C, an arrow is added to form Xⱼ→Xₖ based on Rule 1 of the orientation rules.

Step 7: If there is a directed path from Xᵢ to Xₖ and an undirected edge between Xᵢ and Xₖ in a graph obtained by adding a number of arrows to graph C, an arrow is added to form Xᵢ→Xₖ based on Rule 2 of the orientation rules.

Next, a specific example of the reconstruction of an independent directed acyclic graph by applying a PC algorithm shall be explained. Assuming the case where the independent directed acyclic graph shown in FIG. 1 is hidden, the PC algorithm is applied to the five variables X₁-X₅. In step 1, a completely undirected graph having the five variables as the set of all variables is taken as the initial state. In step 2, the initial value of n is set to 0.

Step 3 shall be explained in stages in accordance with the value of n. FIG. 4 is an undirected graph that is generated in the process of generating the independent directed acyclic graph. FIG. 5 is a partially undirected graph generated in the process of generating the independent directed acyclic graph. The determination of independence is performed by finding a partial correlation coefficient Pᵢⱼ for the variable series consisting of the variable Xᵢ, the variable Xⱼ and the partial set S (which may be the null set), then using a statistical hypothesis test to determine whether it is possible to set Pᵢⱼ=0, as described above. First, the independence of two variables is found with n=0. Here, it is understood that X_{1—}X₂ and X_{2—}X₄, so that the edge between the variables X₁ and X₂ and the edge between the variables X₂ and X₄ can be eliminated. The Sepset for these pairs of variables is the null set.

Next, with n=1 and given one variable, the conditional independence relationships between pairs of variables other than (X₁, X₂) and (X₂, X₄) are determined. For example, for the variable pair (X₃, X₄), it is possible to find whether any of “X_{3—}X₄|X₁”, “X_{3—}X₄|X₂”, or “X_{3—}X₄|X₅” is true. Here, “X_{3—}X₄|X₁” is true, so that the edge connecting the variable X₃ and the variable X₄ is eliminated, and the element X₁ is registered as an element of Sepset(X₃, X₄). Furthermore, it is confirmed that “X_{1—}X₅|(X₃, X₄)” is true when n=2, so (X₃, X₄) is registered as an element of Sepset (X₁, X₅). At the stage of n=2, the undirected graph of FIG. 4 is obtained. Next, the procedure advances to n=3, but in FIG. 4, there are already no nodes that are adjacent to four nodes, so step 3 is ended and the procedure proceeds to step 5.

In step 5, it is determined whether Xⱼ is present among the elements of Sepset(Xᵢ, Xₖ) for each structure Xᵢ-Xⱼ-Xₖ existing in the graph. Listing all of the structures Xᵢ-Xⱼ-Xₖ in the undirected graph shown in FIG. 4 gives the six structures “X₂-X₃-X₁”, “X₃-X₁-X₄”, “X₁-X₄-X₅”, “X₁-X₃-X₅”, “X₂-X₃-X₅” and “X₃-X₅-X₄”. Here, for example, with regard to “X₃-X₁-X₄”, X₁ exists among the elements of Sepset(X₃, X₄), so that this path is found not to be a V-structure. Additionally, with regard to “X₂-X₃-X₁”, X₃ does not exist among the elements of Sepset(X₂, X₁), so this path is found to be a V-structure, and arrows are added so “X₂→X₃” and “X₁→X₃”. By performing such determinations for the six structures described above, it is possible to obtain a partially undirected graph as shown in FIG. 5.

Next, the procedures of step 6 and step 7 would normally be performed, but the partially undirected graph shown in FIG. 5 does not contain any structures to which Rule 1 and Rule 2 of the orientation rules can be applied. In fact, even if arrows facing in either direction are appended to the edge connecting node X₁ with node X₄, the independence and conditional independence of the graph overall will be the same. The PC algorithm described above is described, for example, in Miyakawa, M., Series <Yosoku to Hakken no Kagaku> 1, Toukeiteki inga suiron—Kaikibunseki no atarashii wakugumi—[Series <Science of Prediction and Discovery> 1, Statistical Causal Inference—New Framework for Regression Analysis—], Asakura Shoten, 2004. Additionally, techniques for reconstructing independent directed acyclic graphs are not limited to PC algorithms, and other methods such as SGS algorithms exist.

In data mining based on the reconstruction of independent directed acyclic graphs as described above, a partial correlation coefficient matrix must be computed, for example, in order to determine the conditional independence represented by X_{i—}Xⱼ|S. However, when there is a high level of multicolinearity between Xᵢ, Xⱼ and S, in other words, when there is a strong linear relationship between Xᵢ, Xⱼ and S, the divisors in the computation process will become extremely small. As a result, computational errors can occur as a result of overflow, causing computations to be interrupted or aborted without being completed, and causing the problem of not being able to obtain an independent directed acyclic graph. Additionally, even if an independent directed acyclic graph is obtained, insufficient numbers of data samples or noise occurring during data observation can cause the outputted independent directed acyclic graphs to differ depending on the order of the variables X forming the set of all variables V.

### BRIEF SUMMARY OF THE INVENTION

The present invention was made to overcome the above problems, and has the purpose of offering a graph generating method and graph generating program capable of obtaining independent directed acyclic graphs at a high rate of success. It has the additional purpose of offering a graph generating method and graph generating program capable of increasing the reliability of the resulting independent directed acyclic graphs. It has the further purpose of offering a data mining system that operates based on the graph generating program described above, capable of obtaining highly reliable independent directed acyclic graphs.

In order to solve the above-described technical problems, the graph generating method and graph generating program of the present invention comprise a step of establishing nodes corresponding to all variables in a given set of all variables and establishing a completely undirected graph formed by connecting all pairs of nodes with an undirected edge; a step of selecting a first variable and a second variable from the set of all variables formed from the variables arranged in a predetermined order, and selecting a partial set given as the null set or a set consisting of at least one variable other than the first variable and the second variable; a step of determining whether the first variable and the second variable are conditionally independent when given the partial set, and if conditionally independent, deleting the undirected edge connecting the node corresponding to the first variable and the node corresponding to the second variable; a step of converting undirected edges to arrows based on a determination relating to V-structures; and a step of converting undirected edges to arrows based on at least one orientation rule; wherein an inverse matrix of a correlation coefficient matrix is calculated for a variable sequence consisting of the first variable and the second variable which are the subject of the conditional independence determination and the partial set used in the conditional independence determination, and the operation of determining the conditional independence of the first variable and the second variable is skipped when the diagonal element relating to the first variable in the inverse matrix is greater than a predetermined threshold value or the diagonal element relating to the second variable in the inverse matrix is greater than the predetermined threshold value.

Additionally, the graph generating method and graph generating program of the present invention comprise a step of establishing a number of graphs to be generated; a step of randomly establishing the order of variables forming a given set of all variables each time a graph is generated; a step of establishing nodes corresponding to all variables in the set of all variables and establishing a completely undirected graph formed by connecting all pairs of nodes with an undirected edge; a step of selecting a first variable and a second variable from the set of all variables formed of variables arranged in the established order and selecting a partial set given as the null set or a set consisting of at least one variable other than the first variable and the second variable; a step of determining whether or not the first variable and the second variable are conditionally independent when given the partial set, and if conditionally independent, deleting the undirected edge connecting the node corresponding to the first variable and the node corresponding to the second variable; a step of converting undirected edges to arrows based on a determination relating to V-structures; a step of converting undirected edges to arrows based on at least one orientation rule; and a step of outputting a comprehensive graph including all edges present on any of the graphs generated to express the relationships between variables for each graph generated.

Additionally, the graph generating method and graph generating program of the present invention comprise a step of calculating a probability of existence obtained by dividing the cumulative number of times each edge exists in a graph by the predetermined number of times in which the set of graphs are generated; wherein the probability of existence corresponding to each existing edge is shown on the outputted comprehensive graph.

Additionally, the graph generating method and graph generating program of the present invention comprise a step of calculating, for each edge, at least the cumulative number of undirected edges, the cumulative number of arrows pointing in a first direction and the cumulative number of arrows pointing in a second direction opposite to the first direction; and a step of calculating, for each edge, the probability of existence corresponding to each type of edge obtained by dividing the cumulative number of undirected edges, the cumulative number of arrows pointing in the first direction and the cumulative number of arrows pointing in the second direction by the number of graphs generated; wherein the outputted comprehensive graph indicates the type of edge having the highest probability of existence and the probability of existence of that type of edge.

Additionally, a data mining system of the present invention comprises input means for inputting at least observed data and a number of graphs to be generated; operation means for generating a plurality of graphs while randomly establishing the order of variables forming a given set of all variables each time a graph is generated, calculating a probability of existence obtained by dividing the cumulative number of times each edge exists in a graph by the predetermined number of times in which the set of graphs are generated, and outputting data relating to the structure of a graph showing the relationships between variables and probabilities of existence of edges; memory means for storing at least observed data, the number of graphs to be generated, data relating to the structures of the graphs and probabilities of existence of the edges, and offering a workspace for performing numerical operations; and display means for displaying a graph at least based on the outputted data; wherein the edges whose probability of existence is greater than 0 are all displayed on the display means in a comprehensive graph showing the relationships between variables.

Additionally, the data mining system of the present invention is such that the probabilities of existence are appended to the edges on the display means.

Additionally, the data mining system of the present invention is such that the thicknesses of the edges or the colors of the edges are changed depending on the probabilities of existence on the display means.

According to the present invention, the structure is such that an inverse matrix of a correlation coefficient matrix is calculated for a variable sequence consisting of the first variable and the second variable which are the subject of the conditional independence determination and the partial set used in the conditional independence determination, and the operation of determining the conditional independence of the first variable and the second variable is skipped when the diagonal element relating to the first variable in the inverse matrix is greater than a predetermined threshold value or the diagonal element relating to the second variable in the inverse matrix is greater than the predetermined threshold value, as a result of which it is possible to avoid interruptions and abortions of operations due to errors caused by high degrees of multicolinearity, thus enabling graphs showing the relationships between variables indicating the states of observed items to be obtained at a high rate of success.

The present invention comprises a step of establishing a number of graphs to be generated; a step of randomly establishing the order of variables forming a given set of all variables each time a graph is generated; a step of generating a graph for the set of all variables consisting of the randomly established variables; and a step of outputting a comprehensive graph including all edges present on any of the graphs generated to express the relationships between variables for each graph generated, so that it is possible to obtain a graph comprehensively expressing graphs generated a number of times even in cases where a graph showing the relationship between variables cannot be specified in a single pattern due to noise occurring during data observation or insufficient data samples, thus preventing erroneous interpretations of relationships between variables from being taken by users.

The present invention comprises a step of calculating a probability of existence obtained by dividing the cumulative number of times each edge exists in a graph by the predetermined number of times in which the set of graphs are generated; wherein the probability of existence corresponding to each existing edge is shown on the outputted comprehensive graph, thus enabling the relationships between variables to be accurately understood.

The present invention comprises a step of calculating, for each edge, at least the cumulative number of undirected edges, the cumulative number of arrows pointing in a first direction and the cumulative number of arrows pointing in a second direction opposite to the first direction; and a step of calculating, for each edge, the probability of existence corresponding to each type of edge obtained by dividing the cumulative number of undirected edges, the cumulative number of arrows pointing in the first direction and the cumulative number of arrows pointing in the second direction by the number of graphs generated; wherein the outputted comprehensive graph indicates the type of edge having the highest probability of existence and the probability of existence of that type of edge, thus enabling the details of the types of relationships between variables to be accurately understood.

The present invention is such that probabilities of existence are appended to all edges in the comprehensive graph showing the relationships between variables are displayed on the display means, so that a comprehensive graph including even edges with a low probability of existence is shown to the user, thus preventing users from making erroneous interpretations of the relationships between variables.

The present invention is such that the edges are displayed with the probabilities of existence on the display means, thus enabling the user performing the data mining to readily and accurately understand the relationships between variables

The present invention is such that the probabilities of existence are displayed by changing the thicknesses of the edges or changing the colors of the edges on the display means, so that users performing data mining will be able to more intuitively understand the relationships between variables.

The present invention can be widely applied to data mining systems for discovering and analyzing the relationships between observed items based on various types of observed data.

### BRIEF DESCRIPTION OF THE DRAWINGS

FIG. 1 is a diagram showing an example of an independent directed acyclic graph.

FIG. 2 is a diagram showing an example of an independent directed acyclic graph with partial regression coefficients appended.

FIG. 3 is a diagram showing orientation rules.

FIG. 4 is a diagram showing an example of an undirected graph generated in the process of generating an independent directed acyclic graph.

FIG. 5 is a diagram showing an example of a partially undirected graph generated in the process of generating an independent directed acyclic graph.

FIG. 6 is a flow chart showing the algorithm for a graph generating method according to Embodiment 1.

FIG. 7 is a diagram showing an example of a comprehensive graph with the probability of existence of each edge added.

FIG. 8 is a flow chart showing an algorithm for a relational graph reconstruction process.

FIG. 9 is a flow chart showing an algorithm for an edge elimination process based on conditional independence determination.

FIG. 10 is a flow chart showing an algorithm for an edge elimination process based on conditional independence determination.

FIG. 11 is a diagram showing an example of the structure of a system for performing data mining using the graph generating method of the present invention.

### DETAILED DESCRIPTION OF THE INVENTION

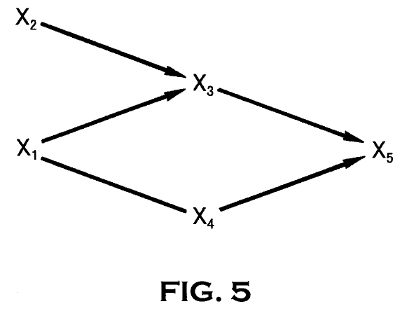

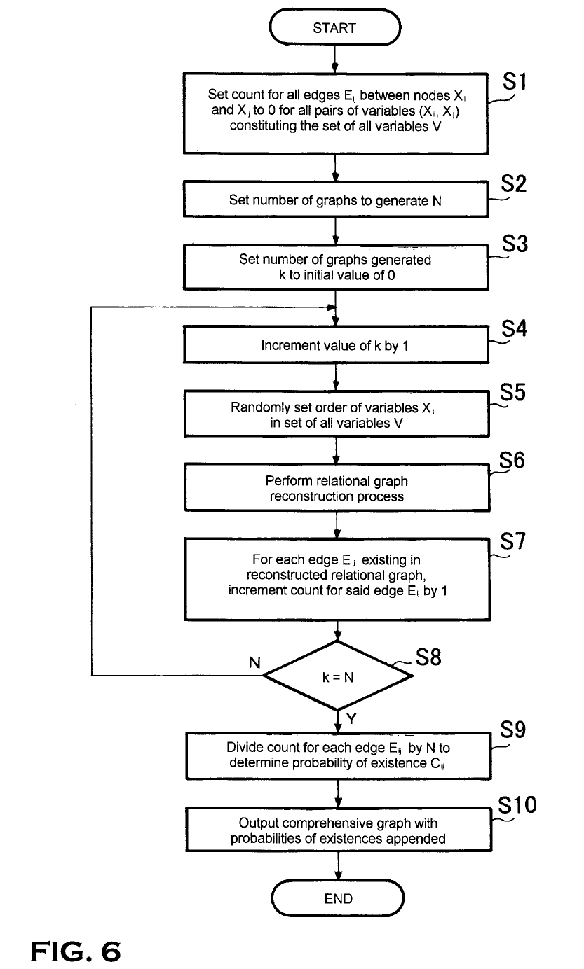

FIG. 6 is a flow chart showing the algorithm for a graph generating method according to Embodiment 1 of the present invention. In the present invention, a technique of reconstructing independent directed acyclic graphs is used to generate graphs representing the relationship between variables indicating the states of observed items. As shown in FIG. 5, a graph representing the relationships between variables may also ultimately be a partially undirected graph. Therefore, in the following description, a graph that has been finally obtained using a technique for reconstructing independent directed acyclic graphs and representing the relationships between variables shall be referred to as a relational graph. It should be obvious that such relational graphs will include independent directed acyclic graphs and partially undirected graphs. The graph generating method shown in FIG. 6 is one in which a predetermined number N (set by the user) of graphs are generated, the probability of existence of edges is determined from the N relational graphs that have been generated, and a comprehensive graph is outputted together with the probability of existence for each edge. Given the set of all variables V={X₁, X₂, . . . , Xₚ}, the initial value of the number of counts for the edge Eᵢⱼ between the node Xᵢ and node Xⱼ is set to 0 for all pairs of variables (X_{i,} Xⱼ) among the variables forming the set of all variables V (step S1).

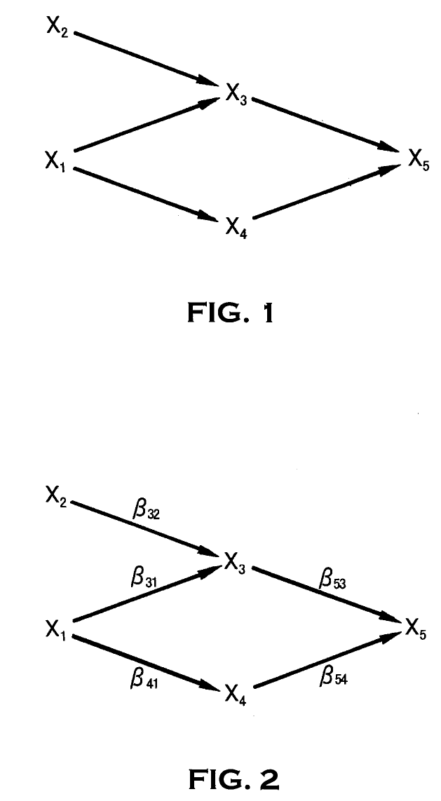

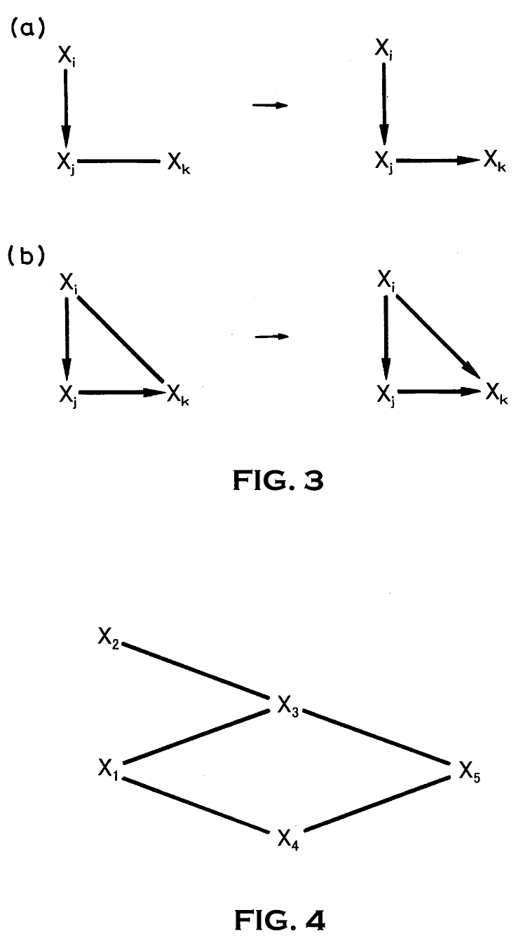

Next, a number N of relational graphs to be generated by the reconstruction process using the PC algorithm is established (step S2). When the number N of graphs to be generated has been established, the initial value of k which indicates the number of the graph currently being generated is set to 0 (step S3). Next, the procedure progresses to the relational graph generating step and the value of k is incremented by 1 (step S4). When the number of the graph being generated k is decided, the order of Xᵢ(i=1 to p) forming the set of all variables V is set randomly in order to generate the k-th relational graph (step S5). In the example of FIG. 1, the set of all variables is given as V={X₁, X₂, X₃, X₄, X₅}. In the relational graph reconstruction process described below, the order of the combinations of (Xᵢ, Xⱼ) and partial set S to be subjected to the conditional independence determination differs depending on the order of the variables in the set of all variables. The presence or absence of conditional independence determined for the previous combination can affect the presence or absence of conditional independence determined for the next combination. Therefore, the order of variables X forming the set of all variables V will affect the form of the reconstructed relational graph. In step S5, the order of the variables Xᵢ(i=1 to p) is set randomly in consideration of this property relating to the reconstruction of relational graphs. For example, using random variables or the like, the set of all variables V having the order V={X₃, X₁, X₄, X₅, X₂} is established as the object of the independent directed acyclic graph reconstruction process using a PC algorithm.

Given the set of all variables V, the PC algorithm is used to perform a relational graph reconstruction process (step S6). This reconstruction process will be discussed in detail below. Once the relational graph is reconstructed by the process of step S6, the count number for each edge Eᵢⱼ existing on the reconstructed relational graph is incremented by 1 (step S7). This completes the reconstruction of the k-th relational graph, whereupon it is determined whether or not the number of generations k is equal to N (step S8). If the number of generations k is found to be unequal to N, this means that N relational graphs have not yet been generated, so that the procedure returns to step S4 to perform another graph reconstruction process.

If the number of generations k is found to be equal to N in step S8, the count number for each edge Eᵢⱼ is divided by the number N of graphs generated (step S9). The value Cᵢⱼ of the count number divided by N indicates the probability of existence of each edge Eᵢⱼ. For example, assume that the number of generations N=10 for the set of all variables V given as V={X₁, X₂, X₃, X₄, X₅}, so that ten independent directed acyclic graphs have been generated. Further assume that as a result, the count for “X₁→X₃” was 10, the count for “X₂→X₃” was 9, the count for “X₁-X₄” was 5, the count for “X₃→X₅” was 10 and the count for “X₄→X₅” was 8. In this case, the probability of existence of “X₁→X₃” is 1.0, the probability of existence of “X₂→X₃” is 0.9, the probability of existence of “X₁-X₄” is 0.5, the probability of existence of “X₃→X₅” is 1.0, and the probability of existence of “X₄→X₅” is 0.8.

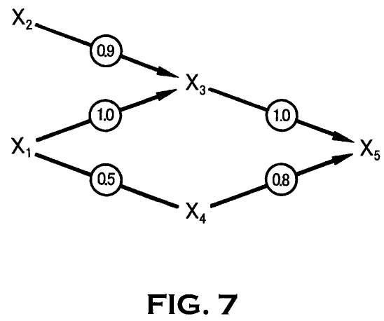

When the probability of existence of each edge Eᵢⱼ has been determined, a comprehensive graph is outputted with each edge labeled with its corresponding probability of existence. FIG. 7 is a graph showing an example of a comprehensive graph having its edges labeled with probabilities of existence. The partially undirected graph shown in FIG. 7 has the probabilities of existence determined in the above example indicated inside circles roughly in the middle of each edge. By randomly setting the order of variables forming the set of all variables and reconstructing the relational graph over plural generations, it is possible to obtain a comprehensive graph that comprehensively expresses the relational graphs generated each time even if it is not possible to specify a single pattern for relational graphs due to lack of sufficient sample data or noise occurring during data observation. Additionally, since the probabilities of existence are appended to each of the edges existing on the comprehensive graph, it is possible to more accurately grasp the relationships between the variables. When different types of edges appear as edges Eᵢⱼ during generation of multiple relational graphs, the node Xᵢ and node Xⱼ is connected in the outputted comprehensive graph by an edge of the type that most often appeared.

In the above embodiment, the count for an edge Eᵢⱼ is incremented by 1 each time the edge is present in a generated relational graph regardless of the type of the edge. Types of edges connecting a node Xᵢ and a node Xⱼ include an undirected edge indicated by “Xᵢ-Xⱼ”, an arrow pointing in a first direction “Xᵢ→Xⱼ” and an arrow pointing in a second direction “Xᵢ←Xⱼ” which is opposite the first direction. Furthermore, in directed graphs formed in certain applications, there are arrows that go in both directions as indicated by “Xᵢ⇄Xⱼ”. Therefore, the structure may be such as to set the count number by the type of edge. In this case, the number of each type of edge is finally compared, and the edge of the type having the highest count is indicated on the graph, with the probability of existence which is the count for that type divided by the number of generations N appended to the edge. For example, when the number of generated graphs is 10, and the count for an edge Eᵢⱼ connecting the node Xᵢ and the node Xⱼ indicating the existence of an undirected edge is 7, and the count indicating the existence of an arrow in a first direction is 3, then node Xᵢ and node Xⱼ will be connected by an undirected edge, and the probability of existence will be 0.7. By indicating the type of edge with the highest probability of existence and the probability of existence of that type on a comprehensive graph outputted as described above, it is possible to more accurately grasp the specifics of the types of relationships between variables.

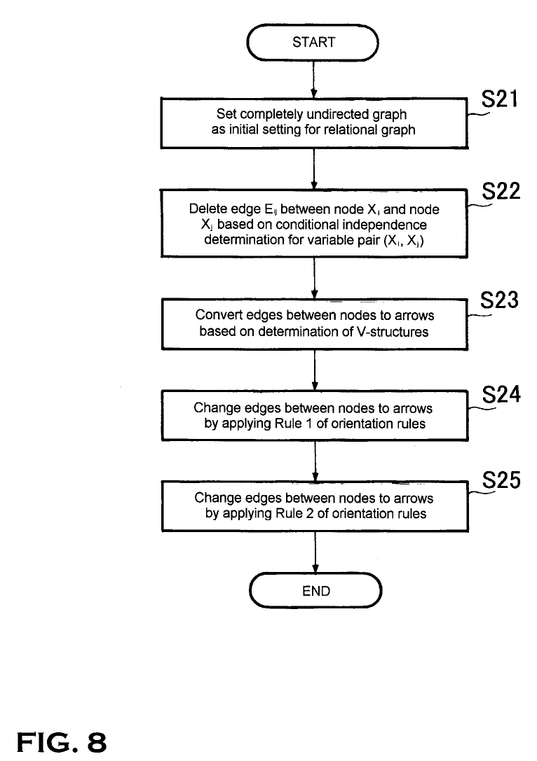

Next, the relational graph reconstruction process of step 6 mentioned above shall be explained. FIG. 8 is a flow chart showing a reconstruction process algorithm for a relational graph. When the set of all variables has been established with a random order, a completely undirected graph is established as the initial graph for the reconstructed relational graph (step S21). This completely undirected graph is constructed by connecting the node Xᵢ and node Xⱼ with an undirected edge for all pairs of variables (Xᵢ, Xⱼ) forming the set of all variables V. Once the initial graph has been established, a conditional independence determination is performed on a pair of variables (Xᵢ, Xⱼ) satisfying predetermined conditions, and if found to be conditionally independent, the edge Eᵢⱼ between the node Xᵢ and the node Xⱼ is deleted (step S22). The details of the edge deletion process based on the conditional independence determination shall be described below.

Upon completion of the edge deletion process based on conditional independence determinations, a determination is performed for V-structures and in structures for which a V-structure has been confirmed, the edge between the nodes is converted to an arrow (step S23). Specifically, for example, if the structure Xᵢ-Xⱼ-Xₖ (Xᵢ and Xₖ are not adjacent) exists in a graph in which the edge deletion process based on conditional independence determinations has been completed as shown in FIG. 4, and the element Xⱼ does not exist in Sepset(Xᵢ, Xₖ) used in the conditional independence determination process, this path is determined to be a V-structure and arrows are appended in the form Xᵢ→Xⱼ←Xₖ.

When the V-structure confirmation process has been completed, Rule 1 of the orientation rules is applied to convert the undirected edges between nodes to arrows based on Rule 1 (step S24). Specifically, when the structure Xᵢ→Xⱼ-Xₖ(Xᵢ and Xₖ are not adjacent) exists in a graph in which the arrow conversion process has been completed based on a check of V-structures as indicated in FIG. 5, the undirected edge between the variable Xⱼ and the variable Xₖ is converted to an arrow to obtain Xᵢ→Xⱼ←Xₖ.

When the arrow conversion process by application of Rule 1 of the orientation rules has been completed, Rule 2 of the orientation rules is applied to convert undirected edges between the nodes based on Rule 2 (step S25). Specifically, if Xᵢ-Xₖ and Xᵢ→Xⱼ→Xₖ exists in a graph after the process of step S24 has been completed, the undirected edge between the variable Xᵢ and the variable Xₖ is converted to an arrow to obtain Xᵢ→Xₖ.

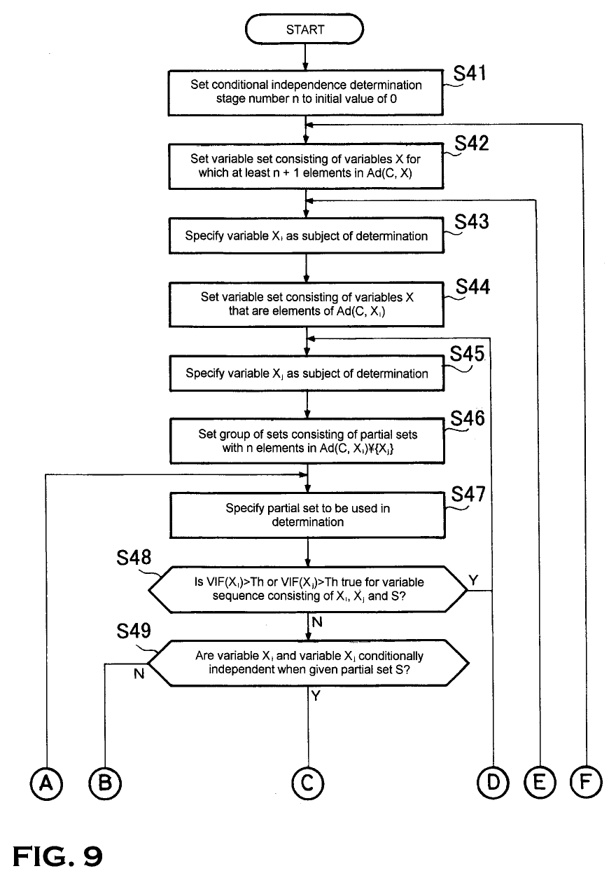

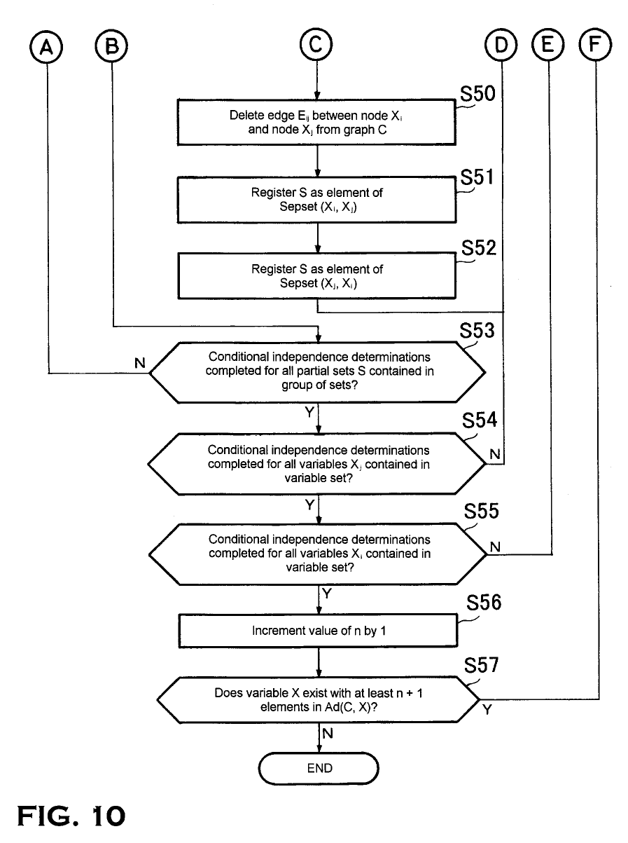

Next, the edge deletion process based on the conditional independence determination in the above step S22 shall be explained. FIG. 9 and FIG. 10 are flow charts showing an edge deletion process algorithm based on conditional independence determination. The letters A, B, C, D, E and F shown in FIG. 9 correspond to the letters A, B, C, D, E and F shown in FIG. 10, such that the flow chart of FIG. 9 and the flow chart of FIG. 10 are connected by these letters. If a completely undirected graph is established as the initial graph for the relational graph, the variable n indicating the number of stages in the conditional independence determination is set to an initial value of 0 (step S41). Herebelow, the graph generated by deleting the edges from the completely undirected graph shall be described as graph C.

When the value of n has been established, variables X in which the number of elements in Ad(C, X) is n+1 or more are sequentially extracted from the graph C, and the set of variables X satisfying this condition is established (step S42). Since the order of variables affects operations in conditional independence determinations as described above, the order of variables X in this variable set is made to agree with the order of variables in the set of all variables established in step S5. When the set of variables has been established, the variables are removed one at a time according to their order in the variable set, and a variable Xᵢ to be the object of the conditional independence determination is specified (step S43).

When the variable Xᵢ to undergo the conditional independence determination has been specified, a variable set consisting of the variables X forming the elements of Ad(C, Xᵢ) is set (step S44). The order of variables inside this variable set is also made to agree with the order of variables in the set of all variables established in step S5. When the variable set has been established, the variables are removed one at a time according to their order in the variable set, to specify a variable Xᵢ to undergo the conditional independence determination (step S45).

When the variable Xⱼ to undergo a conditional independence determination has been specified, partial sets consisting of elements of Ad(C, Xᵢ)¥{Xⱼ} with n elements are sequentially extracted, to establish a group of sets consisting of one or a plurality of partial sets (step S46). When this group of sets has been established, a partial set S to be used in the conditional independence determination is selected from among this group of sets (step S47).

When the variable Xᵢ and variable Xⱼ to undergo the conditional independence determination and the partial set S to be used in the conditional independence determination have been specified, the inverse matrix of the correlation coefficient matrix is calculated with the variable sequence consisting of the variable Xᵢ, variable Xⱼ and the partial set S as the object. The diagonal elements relating to the variable Xᵢ in said inverse matrix shall be indicated as Rⁱⁱ and the diagonal elements relating to the variable Xⱼ shall be indicated as R^{jj}. Here, an index known as VIF (Variance Inflation Factor) is introduced as a measure for evaluating the multicolinearity of the variable Xᵢ and the variable Xⱼ. The VIF(Xᵢ) of variable Xᵢ is equal to Rⁱⁱ, and the VIF(Xⱼ) relating to the variable Xⱼ is equal to R^{jj}. When the value of VIF(Xᵢ) is greater than a predetermined threshold value Th, or the value of VIF(Xⱼ) is greater than a predetermined threshold value Th, the multicolinearity between Xᵢ, Xⱼ and S is determined to be high, in other words, that a strong linear relationship exists between Xᵢ, Xⱼ and S. Here, it is determined whether or not the relationship VIF(Xᵢ)>Th or VIF(Xⱼ)>Th is true for the variable sequence consisting of Xᵢ, Xⱼ and S (step S48).

In step S48, if VIF(Xᵢ)>Th or VIF(Xⱼ)>Th is true, the edge Eᵢⱼ between the node Xᵢ and the node Xⱼ is locked. That is, as mentioned above, when the multicolinearity between Xᵢ, Xⱼ and S is high, there is a high probability that an error will occur in the operations on the partial correlation coefficient matrix for determining the conditional independence between the variable Xᵢ and the variable Xⱼ, so that all operations relating to the conditional independence determination between the variable Xᵢ and the variable Xⱼ are skipped to avoid interruptions or abortions of operations due to errors, and the procedure is moved to step S45.

In step S48, if VIF(Xᵢ)>Th or VIF(Xⱼ)>Th is not true, it is determined whether or not the variable Xᵢ and the variable Xⱼ are conditionally independent when given a partial set S (step S49). Specifically, the partial correlation coefficient Pᵢⱼ is calculated in the variable sequence consisting of the variable Xᵢ, variable Xⱼ and the partial set S. When the partial correlation coefficient Pᵢⱼ has been determined, statistical hypothesis testing is used to determine whether or not the null hypothesis H₀:P_{ij|pa}=0 (the conditions of the partial set S being expressed by pa) can be rejected. When the null hypothesis H₀ cannot be rejected, then it is assumed that P_{ij pa}=0, and variable Xᵢ and variable Xⱼ are determined to be conditionally independent when given a partial set S.

In step S49, when the variable Xᵢ and variable Xⱼ are determined to be conditionally independent, the edge Eᵢⱼ between the node Xᵢ and the node Xⱼ is removed from the graph C (step S50). Additionally, the partial set S is registered as an element of Sepset(Xᵢ, Xⱼ) (step S51), and the partial set S is registered as an element of Sepset(Xⱼ, Xᵢ) (step S52). Since the edge Eᵢⱼ between the node Xᵢ and the node Xⱼ has been deleted by the process in step S50, there is no need to perform operations for conditional independence of the variable Xᵢ and the variable Xⱼ, so that once the process of step S52 has been completed, the procedure moves to step S45.

When the variables Xᵢ and Xⱼ are determined not to be conditionally independent in step S49, it is determined whether or not the conditional independence determination has been completed for all partial sets S forming the group of sets satisfying the conditions defined in step S46 (step S53). If it is determined that a conditional independence determination has not been made on all partial sets S, the procedure moves to step S47, and a new partial set S is specified.

If it is determined in step S53 that the conditional independence determination has been completed for all partial sets S contained in the group of sets, it is determined whether or not the conditional independence determination has been completed for all variables Xⱼ forming the variable set that satisfy the conditions defined in step S44 (step S54). If it is determined that a conditional independence determination has not been made on all of the variables Xⱼ, the procedure moves to step S45 and a new variable Xⱼ is specified.

If it is determined in step S54 that the conditional independence determination has been completed for all variables Xⱼ contained in the variable set, it is determined whether or not the conditional independence determination has been completed for all variables Xᵢ forming the variable set satisfying the conditions defined in step S42 (step S55). If it is determined that a conditional independence determination has not been completed on all variables Xᵢ, then the procedure moves to step S43, and a new variable Xᵢ is specified.

If it is determined in step S55 that the conditional independence determination has been completed for all variables Xᵢ contained in the variable set, the variable n indicating the stage of the conditional independence determination is incremented by 1 (step S56). Next, it is determined whether or not a variable X for which the number of elements Ad(C, X) is n+1 or more exists on the graph C (step S57). If a variable X satisfying this condition exists, then the procedure moves to step S42, and a new variable set is established for the variable X satisfying the conditions. If no variable X satisfying the conditions exists, then the edge deletion process based on conditional independence determination is ended.

In the above-described edge deletion process based on conditional independence determination, an inverse matrix of a correlation coefficient matrix is calculated for the variable sequence consisting of the variable Xᵢ and the variable Xⱼ undergoing the conditional independence determination and the partial set S of variables used in the conditional independence determination, and when the diagonal element Rⁱⁱ relating to the variable Xᵢ in the inverse matrix is greater than a predetermined threshold value Th or the diagonal element R^{jj} relating to the variable Xⱼ in the inverse matrix is greater than the predetermined threshold value Th, the operation for determining the conditional independence of the variable Xᵢ and the variable Xⱼ is skipped, making it possible to avoid interruptions or abortions of operations due to these errors, and enabling a relational graph to be obtained at a high rate of success.

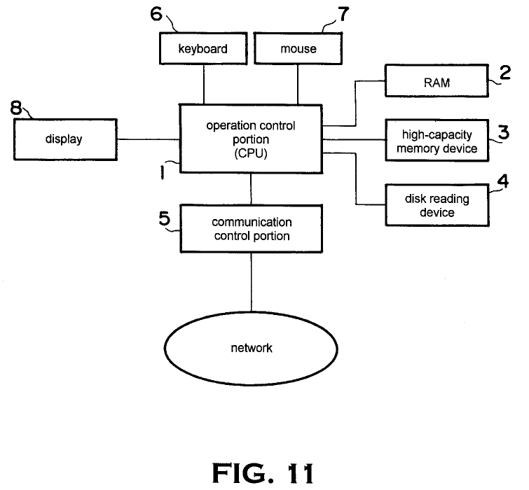

FIG. 11 is a diagram showing an example of the structure of a system for performing data mining using a graph generation program in accordance with the present invention. In FIG. 11, 1 denotes an operation control portion (CPU) for performing the various operations involved in graph generation and controlling the elements of the system, 2 denotes a RAM used as a loading area for a graph generating program or as a workspace for performing operations, 3 denotes a high-capacity memory device such as an HDD in which a graph generating program or observed data are stored, 4 denotes a disk reading device for reading various data such as observed data from a portable memory medium such as a CD or DVD, 5 denotes a communication control portion connected to a communication network such as internet to transmit and receive various types of information, 6 denotes a keyboard for inputting various types of information such as the number of graphs to generate or observed data, 7 denotes a mouse for inputting various types of information such as commands, and 8 denotes a display for displaying a completely undirected graph as an initial setting or a comprehensive graph to which probabilities of existence have been appended.

The system shown in FIG. 11 can be put into practice, for example, in the form of a personal computer or a work station. A program for performing the algorithms indicated by the flow charts shown in FIGS. 6 and 8-10 is stored, for example, in a high-capacity memory device 3, and loaded into the RAM 2 for execution. Additionally, a database for use in data mining having the various types of observed data organized is preferably constructed in the high-capacity memory device 3. The observed data are read from portable memory media such as a CD or DVD using the disk reading device 4, received from a server or the like connected to a network using a communication control portion 5, or inputted as data using the keyboard 6, to be stored in the high-capacity memory device 3. Additionally, a comprehensive graph obtained using the graph generating method of the present invention is displayed on the display 8. At this time, the probabilities of existence of the edges are preferably displayed on the graph as shown in FIG. 7. The probability of existence of an edge does not necessarily need to be indicated numerically. For example, the structure may be such as to express the probability of existence by the thickness of the edges or the colors of the edges.

As described above, the data mining system of the present invention is such that a graph is displayed on the display with the probabilities of existence of the edges appended, so that a user performing data mining can readily and accurately understand the relationships between the variables. Additionally, by expressing the probabilities of existence of the edges by the thickness of the edges or the colors of the edges, a user performing data mining can more intuitively understand the relationships between the variables.

The graph generating method, graph generating program and data mining system explained in the above embodiments are not such as to limit the present invention, and are disclosed with the intention of serving as examples. The technical scope of the present invention shall be determined by the recitations of the claims, and various design changes are possible within the technical scope recited in the claims. For example, while a PC algorithm is used as the algorithm for reconstructing an independent directed acyclic graph in the above embodiment, the structure may be such as to use various algorithms included within the range of the graph generating method applying an independent directed acyclic graph reconstruction technique indicated by the procedures described in the claims, such as a SGS algorithm.

1. A graph generating method for outputting a relationship between variables, comprising:
a step of establishing nodes corresponding to all variables in a given set of all variables and establishing a completely undirected graph formed by connecting all pairs of nodes with an undirected edge;
a step of selecting a first variable and a second variable from the set of all variables formed from the variables arranged in a predetermined order, and selecting a partial set given as the null set or a set consisting of at least one variable other than said first variable and said second variable;
a step of determining whether said first variable and said second variable are conditionally independent when given said partial set, and if conditionally independent, deleting the undirected edge connecting the node corresponding to said first variable and the node corresponding to said second variable;
a step of converting undirected edges to arrows based on a determination relating to V-structures; and
a step of converting undirected edges to arrows based on at least one orientation rule;
wherein an inverse matrix of a correlation coefficient matrix is calculated for a variable sequence consisting of said first variable and said second variable which are the subject of the conditional independence determination and said partial set used in the conditional independence determination, and the operation of determining the conditional independence of said first variable and said second variable is skipped when the diagonal element relating to said first variable in said inverse matrix is greater than a predetermined threshold value or the diagonal element relating to said second variable in said inverse matrix is greater than the predetermined threshold value.

2. A graph generating method comprising:
a step of establishing a number of graphs to be generated;
a step of randomly establishing the order of variables forming a given set of all variables each time a graph is generated;
a step of establishing nodes corresponding to all variables in the set of all variables and establishing a completely undirected graph formed by connecting all pairs of nodes with an undirected edge;
a step of selecting a first variable and a second variable from the set of all variables formed of variables arranged in the established order and selecting a partial set given as the null set or a set consisting of at least one variable other than said first variable and said second variable;
a step of determining whether or not said first variable and said second variable are conditionally independent when given said partial set, and if conditionally independent, deleting the undirected edge connecting the node corresponding to said first variable and the node corresponding to said second variable;
a step of converting undirected edges to arrows based on a determination relating to V-structures;
a step of converting undirected edges to arrows based on at least one orientation rule; and
a step of outputting a comprehensive graph including all edges present on any of the graphs generated to express the relationships between variables for each graph generated.

3. A graph generating method in accordance with claim 2, comprising a step of calculating a probability of existence obtained by dividing the cumulative number of times each edge exists in a graph by the predetermined number of times in which the set of graphs are generated;
wherein the probability of existence corresponding to each existing edge is shown on the outputted comprehensive graph.

4. A graph generating method in accordance with claim 2, comprising:
a step of calculating, for each edge, at least the cumulative number of undirected edges, the cumulative number of arrows pointing in a first direction and the cumulative number of arrows pointing in a second direction opposite to the first direction; and
a step of calculating, for each edge, the probability of existence corresponding to each type of edge obtained by dividing the cumulative number of undirected edges, the cumulative number of arrows pointing in the first direction and the cumulative number of arrows pointing in the second direction by the number of graphs generated;
wherein the outputted comprehensive graph indicates the type of edge having the highest probability of existence and the probability of existence of that type of edge.

5. A graph generating program for outputting a graph showing the relationships between variables; the program performing:
a step of establishing nodes corresponding to all variables in a given set of all variables and establishing a completely undirected graph formed by connecting all pairs of nodes with an undirected edge;
a step of selecting a first variable and a second variable from the set of all variables formed from the variables arranged in a predetermined order, and selecting a partial set given as the null set or a set consisting of at least one variable other than said first variable and said second variable;
a step of determining whether said first variable and said second variable are conditionally independent when given said partial set, and if conditionally independent, deleting the undirected edge connecting the node corresponding to said first variable and the node corresponding to said second variable;
a step of converting undirected edges to arrows based on a determination relating to V-structures; and
a step of converting undirected edges to arrows based on at least one orientation rule;
wherein an inverse matrix of a correlation coefficient matrix is calculated for a variable sequence consisting of said first variable and said second variable which are the subject of the conditional independence determination and said partial set used in the conditional independence determination, and the operation of determining the conditional independence of said first variable and said second variable is skipped when the diagonal element relating to said first variable in said inverse matrix is greater than a predetermined threshold value or the diagonal element relating to said second variable in said inverse matrix is greater than the predetermined threshold value.

6. A graph generating program performing:
a step of establishing a number of graphs to be generated;
a step of randomly establishing the order of variables forming a given set of all variables each time a graph is generated;
a step of establishing nodes corresponding to all variables in the set of all variables and establishing a completely undirected graph formed by connecting all pairs of nodes with an undirected edge;
a step of selecting a first variable and a second variable from the set of all variables formed of variables arranged in the established order and selecting a partial set given as the null set or a set consisting of at least one variable other than said first variable and said second variable;
a step of determining whether or not said first variable and said second variable are conditionally independent when given said partial set, and if conditionally independent, deleting the undirected edge connecting the node corresponding to said first variable and the node corresponding to said second variable;
a step of converting undirected edges to arrows based on a determination relating to V-structures;
a step of converting undirected edges to arrows based on at least one orientation rule; and
a step of outputting a comprehensive graph including all edges present on any of the graphs generated to express the relationships between variables for each graph generated.

7. A graph generating program in accordance with claim 6, wherein the program performs a step of calculating a probability of existence obtained by dividing the cumulative number of times each edge exists in a graph by the predetermined number of times in which the set of graphs are generated;
wherein the probability of existence corresponding to each existing edge is shown on the outputted comprehensive graph.

8. A graph generating program in accordance with claim 6, wherein the program performs:
a step of calculating, for each edge, at least the cumulative number of undirected edges, the cumulative number of arrows pointing in a first direction and the cumulative number of arrows pointing in a second direction opposite to the first direction; and
a step of calculating, for each edge, the probability of existence corresponding to each type of edge obtained by dividing the cumulative number of undirected edges, the cumulative number of arrows pointing in the first direction and the cumulative number of arrows pointing in the second direction by the number of graphs generated;
wherein the outputted comprehensive graph indicates the type of edge having the highest probability of existence and the probability of existence of that type of edge.

9. A data mining system for generating a graph indicating relationships between variables indicating states of observed items from a group of observed data; comprising:
input means for inputting at least observed data and a number of graphs to be generated;
operation means for generating a plurality of graphs while randomly establishing the order of variables forming a given set of all variables each time a graph is generated, calculating a probability of existence obtained by dividing the cumulative number of times each edge exists in a graph by the predetermined number of times in which the set of graphs are generated, and outputting data relating to the structure of a graph showing the relationships between variables and probabilities of existence of edges;
memory means for storing at least observed data, the number of graphs to be generated, data relating to the structures of the graphs and probabilities of existence of the edges, and offering a workspace for performing numerical operations; and
display means for displaying a graph at least based on the outputted data;
wherein the edges whose probability of existence is greater than 0 are all displayed on said display means in a comprehensive graph showing the relationships between variables.

10. A data mining system in accordance with claim 9, wherein the probabilities of existence are appended to the edges on said display means.

11. A data mining system in accordance with claim 9, wherein the thicknesses of the edges or the colors of the edges are changed depending on the probabilities of existence on said display means.
